(19) United States
(12) Patent Application Publication
(10) Pub. No.: US 2025/0005694 A1
(43) Pub. Date: Jan. 2, 2025

(54) METHOD AND SYSTEM FOR CAREER MAPPING

(71) Applicant: 14047591 Canada Inc., Toronto (CA)

(72) Inventors: Ehizogie MaryMartha AGBONLAHOR, Toronto (CA); Osazuwa Gabriel AGBONLAHOR, Toronto (CA)

(21) Appl. No.: 18/759,035

(22) Filed: Jun. 28, 2024

Related U.S. Application Data
(60) Provisional application No. 63/523,696, filed on Jun. 28, 2023.

(51) Int. Cl. G06Q 50/20

(52) U.S. Cl. CPC G06Q 50/2057

(57) ABSTRACT

A method for recommending a career to a user, the method comprising the steps of: at processing circuitry executing instructions stored in a memory device, receiving raw user data; preprocessing the raw user data; extracting predefined content from the user data; transforming text in the predefined content into frequency distribution and generating a predetermined number of feature vectors; generating a training data set and a test data set from the feature vector output; generating at least one model, and using the training data set and test data set to evaluate the performance of the at least one model; receiving subject user data; predicting the at least one career using the trained model on the subject user data; and generating a report comprising the at least one career.

### CROSS-REFERENCE TO RELATED APPLICATIONS

This patent application claims the benefit of U.S. Provisional Patent App. Ser. No. 63/523,696, filed on Jun. 28, 2023, the disclosure of which is incorporated herein by reference in its entirety.

### FIELD

The present disclosure relates to methods and systems for recommending a career based on user data.

### BACKGROUND

Job recommendation platforms are well known. Generally, job seekers access such platforms and provide information about themselves, including work and education history, and the platforms output available job positions. Generally, these platforms match resumes to user-provided job descriptions, and are not able to auto-generate job matches that the user has not specified. As such, if the user is not aware of the job or career, the platform will be of little assistance. Other solutions focus on matching user supplied data to user supplied job descriptions or job titles, and do not auto-generate job titles tailored to the user based on generic user data without user prompts. In addition, existing platforms provide job recommendations based only on professional activities such as resumes, and projects.

### SUMMARY

In one of its aspects, a method for recommending a career to a user, the method comprising the steps of:
at processing circuitry executing instructions stored in a memory device, receiving raw user data;
preprocessing the raw user data;
extracting predefined content from the user data;
transforming text in the predefined content into frequency distribution and generating a predetermined number of feature vectors;
label encoding an output of each feature vector;
generating a training data set and a test data set from the feature vector output;
generating at least one model, and using the training data set and test data set to evaluate the performance of the at least one model;
receiving subject user data;
predicting the at least one career using the trained model on the subject user data; and
generating a report comprising the at least one career.

In another aspect, a system for recommending a career to a user, the system comprising:
a hardware processor and a memory device on which instructions are encoded to cause the hardware processor to perform the operations of:
receiving raw user data;
preprocessing the raw user data;
extracting predefined content from the user data;
transforming text in the predefined content into frequency distribution and generating a predetermined number of feature vectors;
label encoding an output of each feature vector;
generating a training data set and a test data set from the feature vector output;
generating at least one model, and using the training data set and test data set to evaluate the performance of the at least one model;
receiving subject user data;
predicting the at least one career using the trained model on the subject user data; and
generating a report comprising the at least one career.

In another aspect, a computer readable medium storing instructions executable by a processor to carry out the operations comprising:
receiving raw user data;
preprocessing the raw user data;
extracting predefined content from the user data;
transforming text in the predefined content into frequency distribution and generating a predetermined number of feature vectors;
label encoding an output of each feature vector;
generating a training data set and a test data set from the feature vector output;
generating at least one model, and using the training data set and test data set to evaluate the performance of the at least one model;
receiving subject user data;
predicting the at least one career using the trained model on the subject user data; and
generating a report comprising the at least one career.

In another aspect, a method for mapping a career for a user, the method comprising the steps of:
at processing circuitry executing instructions stored in a memory device, receiving raw user data comprising at least one of professional activities, non-professional activities, education, hobbies, skills, interests, and contemporaneous online user activities;
preprocessing the raw user data to generate user input data;
with a trained model, using the user input data to generate a plurality of potential careers for the user;
ranking the plurality of potential careers;
predicting the at least one career for the user; and
generating a report comprising the at least one career.

Advantageously, there is provided a machine learning model and a data pipeline that maps user profiles into various career paths based on their skills, education, and professional and non-professional activities. To achieve this, the model maps both professional and non-professional activities to specific character traits, and then maps those specific character traits to closely matched industries and then potential careers. Accordingly, a broad range of possible careers across various industries may be predicted and associated with a percentage match. Such outcome would not be possible with existing solutions which generally map skills, and professional activities to specific careers (provided by the user). Furthermore, the machine learning prediction includes career names with similar job titles e.g., data analyst is mapped with data intelligence specialist, etc. In addition, a description of the various jobs and expectations in terms of responsibility is also presented as well as commonly used tools.

In addition, a web and/or mobile application associated with the user facilitates gathering user data, such as extracurricular activities, hobbies, skills, contemporaneous data, social media data etc., which allows the ML model predictions to change dynamically to accommodate changes in the user profile, and interest in real-time.

Furthermore, the system comprises an interactive user interface with which users can improve segments of their resume iteratively, and the final version of the improved resume may be presented to the user for viewing, forwarding to a third party, or saving in a downloadable format.

In one embodiment each job role is analyzed for its suitability to a particular job description and improved by dynamically asking questions to the user on various aspects of the job role, e.g., success metrics, impact of the work done etc., and the responses are integrated into the platform.

In another embodiment each role in the resume is improved without a job description and made to be more suitable for an applicant tracking system (ATS) resume scan and more in line with the STAR resume approach. To achieve this, large language models are used to interact with the user by asking questions such as metrics that quantify achievements in the resume, goals achieved from certain tasks, etc. These details are integrated into the resume to make it better. Additionally, to achieve this retention of answers across conversations, unique user sessions are created with user context stored across conversations. In addition, a resume ranking feature is presented which could help users (in this case employers) to rank resumes submitted for a job and rank these based on the skills in the job descriptions. In this case, resumes are ranked by calculating the cosine similarity between the extracted skills from job descriptions and the skills in the resume, with resumes having the highest cosine similarity ranked higher.

Beneficially, the system enables students to map their career paths, or enable career professionals to switch careers, or find new job opportunities, and enables companies reduce employee chum by suggesting alternative career paths tailored to their employees and opportunities within their organization. In this regard, the system enables a user select a career and it automatically generates future career paths that are likely for the chosen career, hence enabling the user look into their future career prospects.

The system also enables various payment schedules and plans with controlled access to features depending on the payment plan chosen. Furthermore, to aid customization to various users, all the developed features described above can be customized and packaged for deployment for various users in a customizable design interface, and predictions.

### BRIEF DESCRIPTION OF THE DRAWINGS

FIG. 1 shows a top-level diagram of an overall system architecture for recommending a career;

FIG. 2 shows a flow chart with example steps for recommending a career path for a user;

FIG. 3 shows a cloud-based machine learning (ML) model deployment architecture;

FIG. 4 shows a flow chart with example steps for matching a user to a job based on the user's interests, skills, activities;

FIG. 5 shows a ML model development and deployment process;

FIG. 6 shows an integration of the deployed ML algorithms with the career prediction workflow based on the provided user data;

FIG. 7 shows transfer learning techniques using fine-tuned transformer models for zero-shot classification;

FIG. 8 shows a flow chart with example steps for improving a resume by interacting with a user;

FIG. 9 shows a flow chart with example steps for ranking a resume;

FIGS. 10a-b show example user interfaces showing a “STAR” based user capture achievement;

FIGS. 10c-d show example user interfaces showing mapping of user capture achievement to projects, school activities, etc.;

FIGS. 10e-f show example user interfaces showing top career matches; and

FIG. 11 shows an architecture of a computing device configurable to implement aspects of the processes described herein.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the invention in any way. Indeed, for the sake of brevity, certain sub-components of the individual operating components, and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

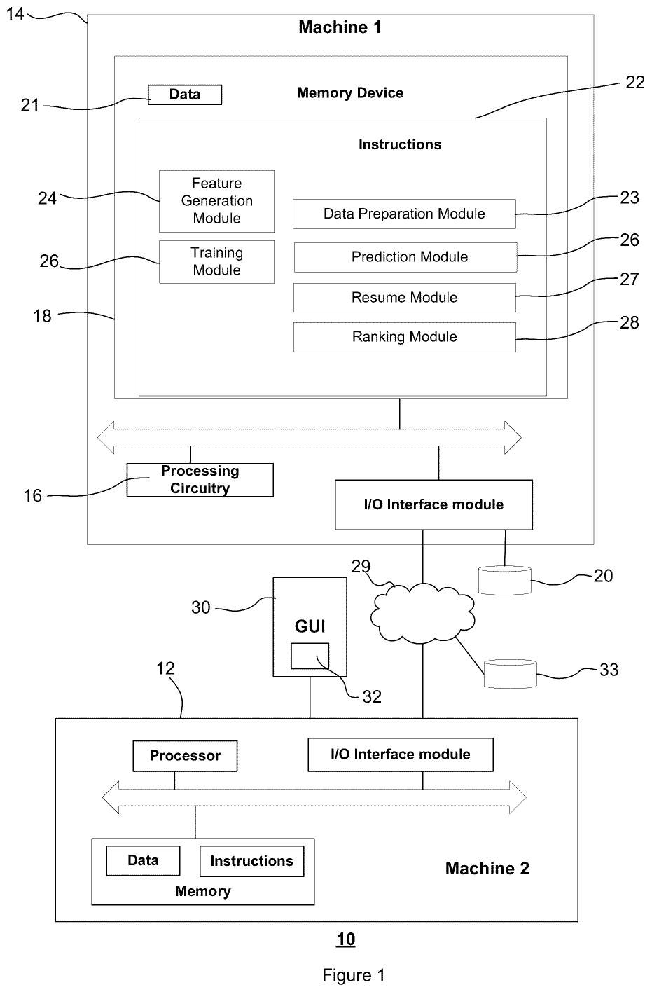

FIG. 1 shows an overall system architecture 10 comprising a user device 12 and a machine or apparatus 14, such as a computing device e.g. back-end processing server, with processing circuitry or processor 16, memory 18 and storage backend 20. In an embodiment, memory 18 is capable of storing data 21, machine executable instructions 22, including data models and process models. Storage backend 20 is coupled to the computing device 14 and stores pre-processed data, model output data and audit data. Further, the processor 16 is capable of executing the instructions 22 stored in memory 18 to implement aspects of processes described herein. For example, the machine 14 comprises instructions 22 executable by processor 16, wherein the software instructions 22 may specifically configure the processor 16 to perform algorithms and/or operations described herein when the software instructions are executed. Alternatively, the processor 16 may execute hard-coded functionality. For example, memory device 16 comprise several modules with instructions 22 stored therein which are executable by the processing circuitry 16. The modules may include a data preparation module 23; a feature generation module 24, a training module 25, prediction module 26; and a resume module 27; and a ranking module 28.

The user device 12 may be communicatively coupled to the machine 14 via a network 29.

Generally, users provide details of their activities, projects, skills, goals, hobbies, interests, projects taken, courses, etc., using a front-end user interface (UI) 30. In addition, user data may be scraped from the Internet and inputted to the machine learning (ML) models 22 or stored in storage backend 20. The ML models 22 use the user input data to provide an output associated with a potential career or job back to the front-end user interface (UI) 30.

In one example workflow, the user interacts with the front-end (UI) 30 and the information is sent to the storage backend 20 (to be used by the ML models 22 in the future). In another workflow, the data collected from the front end (UI) 30 is sent to the ML models 22 to generate information such as career matches, skills, industry tags, resume work blocks, which are sent to the storage backend 20 for use at a later date e.g. for more tailored career mapping. In another workflow, such as career prediction (over time), data already stored for the user is used to predict careers, match users to available jobs, etc. In this case, the stored user data is retrieved from the storage backend 20 without any new user input from the front-end UI 30.

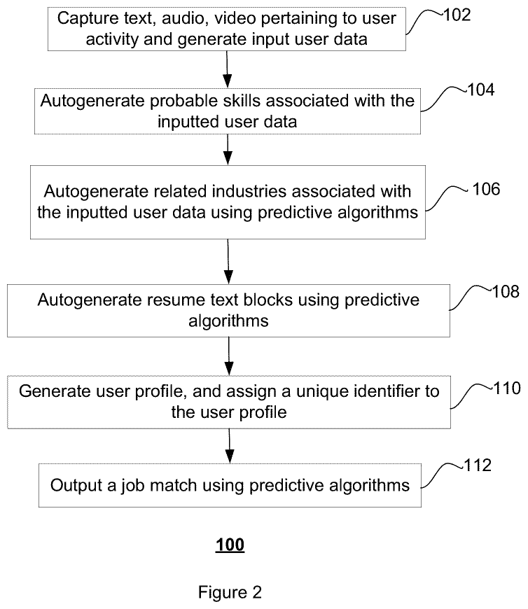

FIG. 2 shows a flow chart 100 with example steps for recommending a career path for a user. In step 102, a web/mobile platform captures text, audio and video pertaining to user activities using a “STAR” (situation, task, action and results) approach to provide details of the user's activities, projects, skills, etc. In addition, details of user activities may be scraped from the Internet, or social media. In one example, in these data acquisition steps, the system 10 captures the input either through text or voice via the UI 30. For example, the machine 14 generates a dialog box or area 32 for presentation on the UI and provides probing questions thereon for the user to answer in an interactive manner. For example, the probing questions help the user reflect on the achievements of the day in a career coaching and storytelling format that captures the salient skills the user is exhibiting. Several datasets are obtained following the above-noted data acquisition steps, and instructions associated with the data preparation module 23 are executed by the processing circuitry 16 to receive the datasets for cleaning and pre-processing and standardization. The system 10 extracts the relevant skills, including skills from the non-professional activities into the user's achievement profile, and the machine 14 then pre-processes the user data.

In step 104, the pre-processed user data is inputted to the prediction module 26 having one or more trained machine learning (ML) models 22 which autogenerate related skills associated with the inputted user data using predictive algorithms associated with the prediction module 26. Instructions associated with the feature generation module 24 are executed by the processing circuitry 16 to extract a particular set of features from extract a particular set of features from the resume and groups the extracted features, such as in one or more feature vectors, to generate the training data.

In step 106, those outputted related skills are input into one or more trained machine learning (ML) models 22 which autogenerate the related industries using predictive algorithms associated with the prediction module 26. Instructions are executed by the processing circuitry 16 to determine the optimal hyperparameters for the prediction models 22. In one example, the datasets for each prediction task are divided into 80% for training and 20% for testing using a scaffold split. A validation set, with a certain percentage of the original data may be used utilized to tune the model parameters and provide an unbiased evaluation of model fit during the training phase.

In step 108, the user data gathered in step 102, the related skills autogenerated in step 104, and related industries autogenerated in step 106 are inputted to one or more trained machine learning (ML) models 22 which autogenerate resume text blocks using predictive algorithms.

In step 110, a user profile comprising the user data, gathered in step 102, the probable skills autogenerated in step 104, and related skills autogenerated in step 106, and the resume text blocks autogenerated in step 108 is assigned a unique identifier and stored in storage backend 20, and linked to a captured project.

In step 112, the user profile is inputted to one or more trained machine learning (ML) models 22 which predict a suitable job or suggest job matches using predictive algorithms, and a suitable report with the suitable job or job matches is generated.

The one or more trained machine learning (ML) models 22 generate artifacts and tags such as related skills, tools, related industries, and resume work blocks. Furthermore, these artifacts can be tagged with one or more projects to which they are related and stored against the user. Accordingly, for every user, the history of the user's skills, projects, industries, professional and non-professional activities over time (weeks, months, years, etc.) may be retrieved on-demand. Consequently, using this stored data, the machine learning models 22 can provide tailored career advice and career maps that are dynamic or contemporaneous in response to the user's ongoing interests. Since the user data is captured over extended periods of time, the possible career options and their percentage match to these careers, can be predicted at any time. As the captured user data evolves, so do the model predictions, hence the user can map their career paths over time even as their interests evolve.

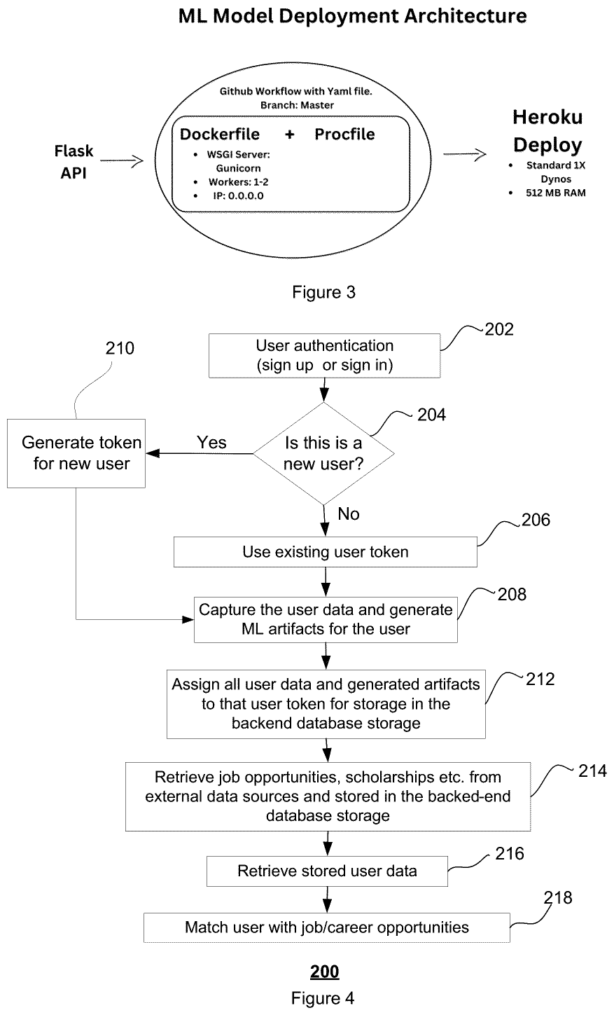

FIG. 3 shows a cloud-based ML deployment architecture. In one example, a trained ML model 22 may be stored as a pickle file using the pickle module which de-serializes a file object by breaking down the object into its constituting components. Generally, the pickle module is useful when dealing with smaller models with fewer parameters. The pickle module keeps track of the objects it has already serialized, such that later references to the same object will not be serialized again, thus allowing for faster execution time.

Alternatively, the trained ML model 22 may be stored as a joblib file such that it can operate on objects with large NumPy arrays/data as a backend with many parameters. Generally, joblib is useful when dealing with larger models with a plurality of parameters that comprises large NumPy arrays in the backend. Accordingly, the pickle/joblib file is wrapped in a REST API (Flask) and then deployed to the Heroku® cloud computing platform from SalesForce Inc., U.S.A. and AWS® cloud computing platform from Amazon Web Services, Inc., U.S.A., as a Docker image using the Gunicorn as a web server gateway interface (WSGI) server, and a Procfile to specify the gunicorn commands to run when the app starts up. In alternative embodiment, full scale end-to-end ML pipeline using AWS Code pipeline to orchestrate the various aspects of the REST API deployment is used. In this case, AWS CodeBuild is used for building the Docker containers using specified BuidlSpec files and the container is deployed as a service on the AWS Elastic Container Service and stored in the Elastic Container Registry.

FIG. 4 shows a flow chart 200 with example steps for matching a user to a job, career, or scholarship based on the user's interests, skills, activities, etc. In step 202, the system 10 assigns a unique token to the user following a user login, after the user is authenticated (e.g., by email, SMS, or an authenticator application). Accordingly, when a user signs in, the system 10 determines whether the user is a new user or a returning user with an existing user token (step 202), and if the user token exists, the system 10 uses the existing token (step 206) and captures the user data and generates ML artifacts for the user, in step 208. However, if the user is new token does not exist, the system 10 generates a new user token (step 210) and captures the user data and generates ML artifacts for the user, in step 208. Furthermore, for certain workflows such as user achievement data capture, the system 10 performs data validation using ML tools (e.g., to detect gibberish text and alert the user of such occurrences), or ensure that the uploaded resume is in the appropriate format (e.g. pdf or docx. etc.). Next, in step 212, the system 10 assigns all user data and generated artifacts to that user token for storage in the storage backend 20.

In step 214, a plurality of job opportunities, scholarships etc. are retrieved from external data sources 33 and stored in the backed-end database storage 20. The stored user data is retrieved using the user token, in step 216. Next, in step 218, the system matches the user to jobs, scholarships etc., based on the interests, skills, activities etc. To match users with job or career opportunities, the system 10 may exchange data with external data sources 33 e.g., LinkedIn jobs etc. using API's such as Rapid API to dynamically capture newly posted jobs, which it then matches to the users based on the ML recommendation.

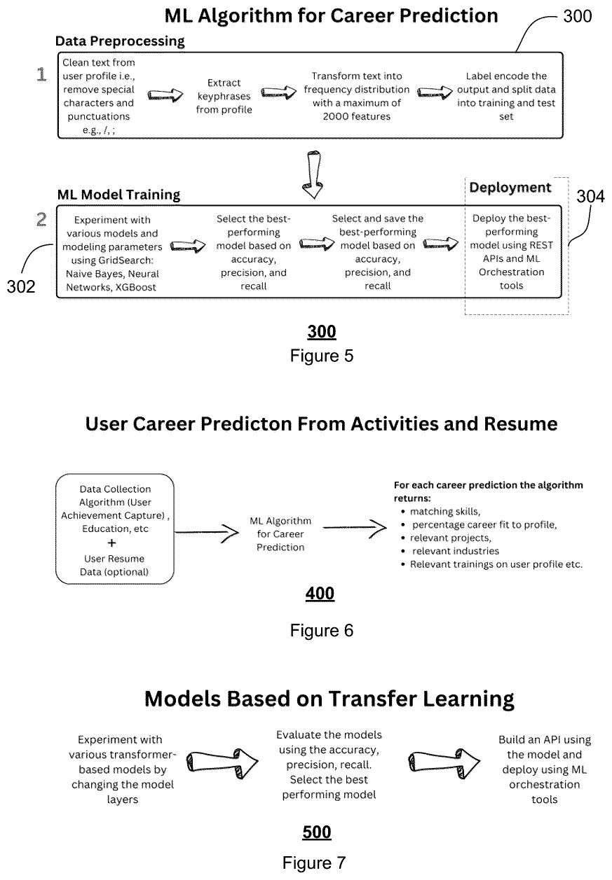

Looking at FIG. 5, the ML model development and deployment process consists of a data processing phase 300, an ML model training phase 302, and a deployment phase 304. The data processing phase 300 comprises the steps of ingesting the text documents and removing punctuations, and ensuring all words are in the same casing. Thereafter, key-phrases are extracted to form the bag of words, and using the term frequency-inverse document frequency (TF-IDF), a frequency distribution of the keywords in the bag of words is generated to for the training input data. Thereafter, the output (classes to be predicted) is label encoded for training.

The ML model training phase 302 comprises evaluating various ML models and modelling parameters using algorithms such as GridSearch, Naïve Bayes, neural networks and XG Boost. The training engine 54 may be configured to train various Models. Generally, the training data set and the feature vectors are used to fully train one or more predictive models. In one example, different machine learning classifiers or algorithms are used for building the predictive models, such as, supervised learning algorithms, unsupervised learning algorithms and reinforcement learning algorithms. Examples of supervised learning algorithm systems include support vector machine, decision tree, linear regression, logistic regression, naive Bayes, k-nearest neighbor, random forest, AdaBoost, XGBoost, and neural network methods. Examples of unsupervised learning algorithm systems include K-means, mean shift, affinity propagation, hierarchical clustering, DBSCAN (density-based spatial clustering of applications with noise), Gaussian mixture modeling, Markov random fields, ISODATA (iterative self-organizing data), and fuzzy C-means systems. Examples of reinforcement learning algorithm systems include Maja and Teaching-Box systems. Generally, training the predictive models involves optimizing the parameters of a predictive system to minimize the loss function. In addition to the training step, the predictive models also undergo validation using test datasets.

As such, in one example, the XGBoost regressor model is trained to use the best hyperparameters obtained. The trained model is then saved to the file system for future use, especially for making predictions on new data. The evaluation phase starts with making predictions on the validation and test sets. The model's performance is evaluated using various metrics, including Root Mean Square Error (RMSE), Mean Absolute Error (MAE), Pearson Correlation, R\hat{ }2, and Concordance Correlation Coefficient (CCC). These metrics provide different lenses through which the model's predictive performance can be assessed. As an example, the XGBoost algorithm is able to automatically handle missing data values, and therefore it is sparse aware, includes block structure to support the parallelization of tree construction, and can further boost an already fitted model on new data i.e. continued training. For example, different ML models may be developed, which include parameters including accuracy, precision, recall, and F1 score functionality. Accordingly, the models are evaluated for their accuracy, precision, recall, and F1-score. In one example, a minimum target F1-score of about 80% is set for these models, and the best performing model, based on these metrics is selected and deployed as a REST API, as described in FIG. 3.

In the deployment phase 304, the best performing model is deployed to the processing server 14, such as cloud-based servers e.g. Heroku or AWS cloud computing platforms.

In FIG. 6 there is shown an integration of the deployed ML algorithms with the career prediction workflow 400 based on the provided user data. In one example, the trained model is used to process user input data including resume data to generate the user career prediction. The ML algorithms may also return matching skills, percentage fit to user profile, relevant projects, relevant industries and relevant trainings on user profile etc., as shown in FIG. 6.

In another example, transfer learning techniques 500 may be used, as shown in FIG. 7. Generally, transfer learning models comprise more complex models which require huge amounts of data (e.g. terabytes of data). For example, the transfer learning models comprise pre-trained transformer models which were fine-tuned to predict new classification problems. This can be achieved by fine tuning the model parameters during re-training. In this case, new data is supplied to the model and the model weights are retrained by experimenting with hyper-parameters such as the number of epochs, learning rate, and batch size. Alternatively, the pretrained model could also be used via a process known as Zero-shot classification in which the pre-trained model weights are used to classify input text into new classes previously untrained by the model. This is achieved by changing the outer layers of the pre-trained transformer models. For example, these models are used for applications such as generation of resume summary blocks, industry tags, etc. from user inputs where large language models are typically required. The trained ML algorithm is then wrapped as a REST API, as described in FIG. 3, and integrated into the desired user workflow, e.g., the user capture achievement.

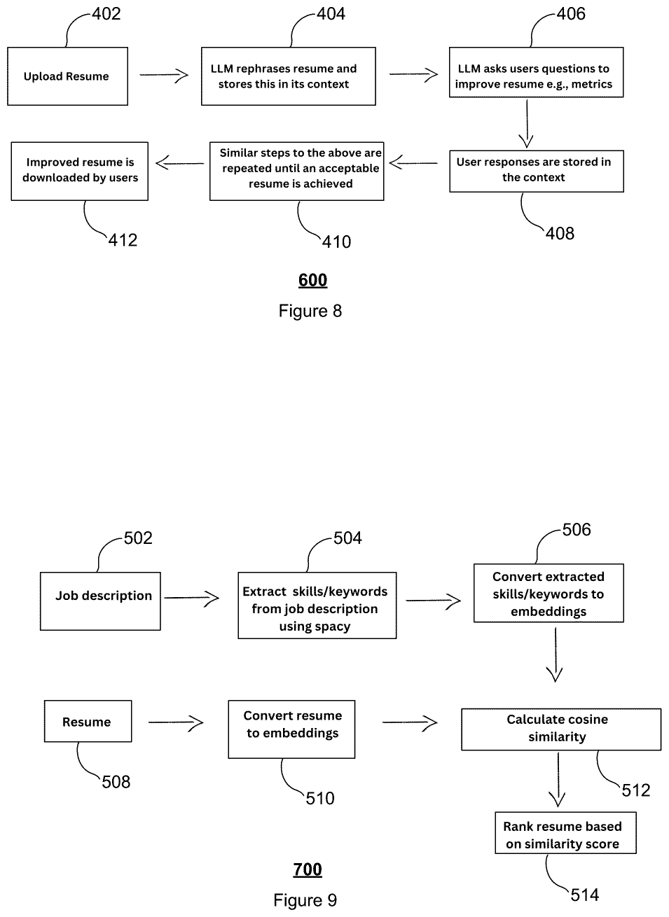

In another embodiment, FIG. 8 shows a flow chart 600 with example steps for improving a resume by interacting with a user and executing instructions associated with the resume module 26 by the processing circuitry 16. In step 402, a resume is received by machine 14, and using the machine learning (ML) models 22 of the resume module 27, the resume is re-written to correct for grammatical and lexical errors, and thereafter this re-written version is stored for future AI-to-user interactions i.e., it is used to improve the understanding of the AI user context (step 404). Next, an automated conversation is conducted using the machine learning (ML) models 22, which allows the user to interact with system 10 by responding to questions posed by the resume module 27. The questions are based on the contents of the resume and may include inquiries regarding metrics that quantify any achievements in the resume, goals achieved from certain tasks, etc. (step 406). These details are integrated into the resume to make in order to improve same, and the afore-mentioned steps may be repeated iteratively until an acceptable and updated resume is achieved (step 410). Additionally, to achieve this retention of answers across conversations, unique user sessions are created with user context stored across conversations. Each role in the resume is improved without a job description and made to be more suitable for ATS resume scan and more in line with the STAR resume approach. In step 412, the updated resume is presented to the user for viewing, forwarding to a third party, or saving in a downloadable format.

In yet another embodiment, FIG. 9 shows a flow chart 700 with example steps for ranking a resume. In step 502, instructions associated with the ranking module 28 are executed by the processing circuitry 16 to rank the resumes based on a predefined criteria. For example, a job description is input into the ranking module 28 and the particular skills and keywords associated with the job description are extracted by the ranking module 27. In one example, spaCy, a free, open-source library for advanced Natural Language Processing (NLP) in Python is employed. In step 506, the extracted skills and keywords are converted to a first set of embeddings, such as vectors of numbers representing the texts, by ranking module 28. In step 508, the ranking module 28 also receives a resume, ostensibly geared towards the above-noted job description, and the resume module 27 analyzes the resume and converts the resume into a second set of embeddings, such as, vectors of numbers representing the texts. Next, the ranking module 28 calculates a cosine similarity score (step 512) between the extracted skills from job descriptions and the skills in the resume The resumes are ranked based on the cosine similarity, for example, resumes having the highest cosine similarity ranked higher. As such, this resume ranking feature may help employer to rank resumes submitted for a job and rank these based on the skills in the job descriptions.

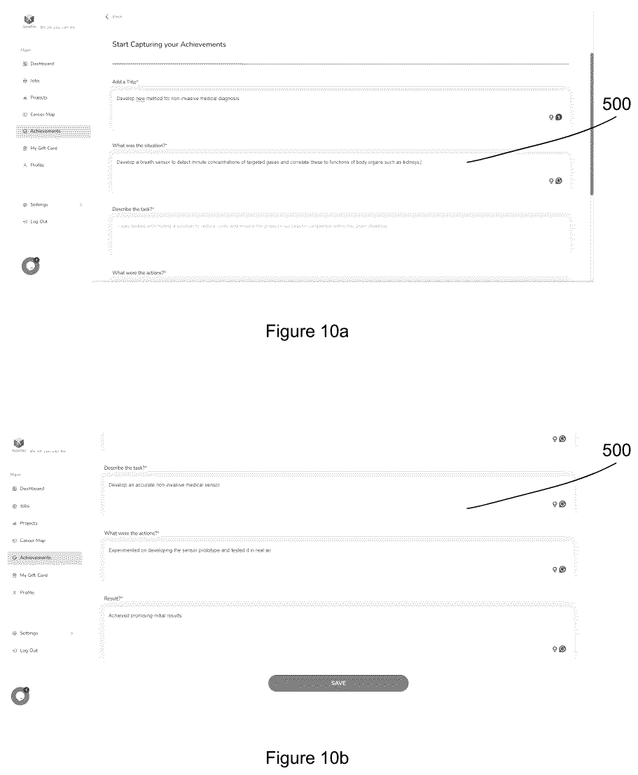

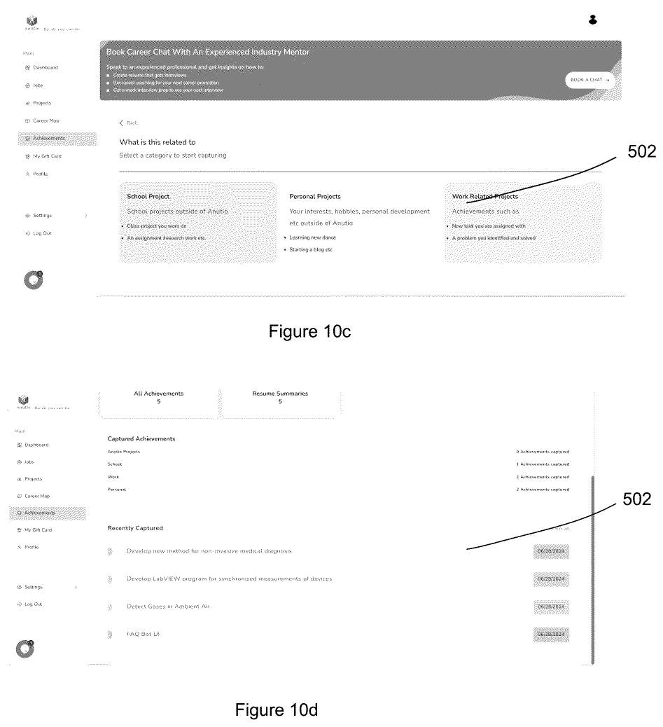

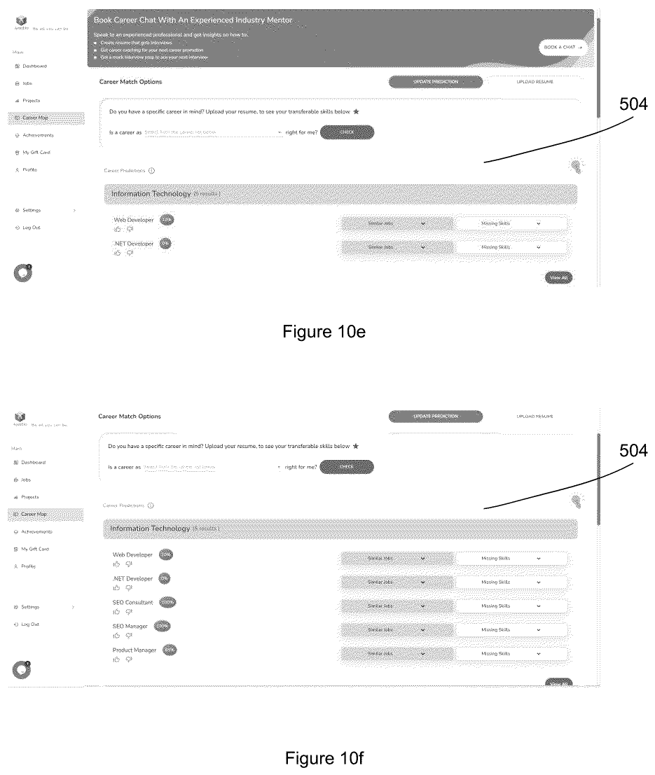

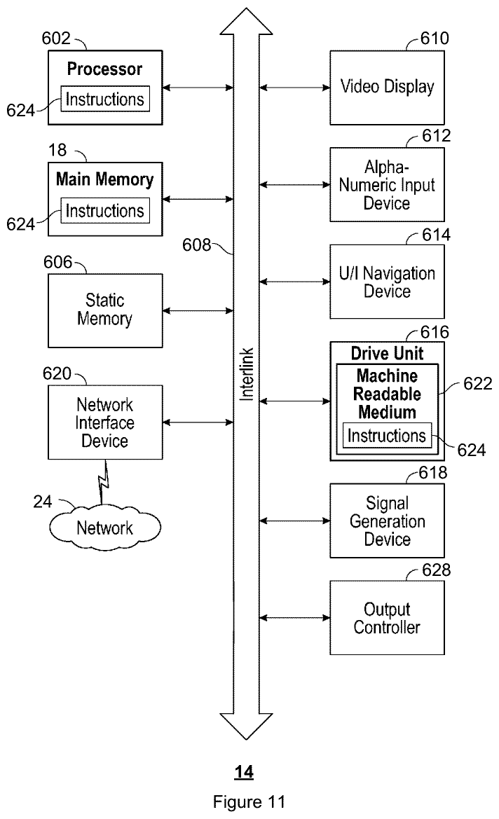

FIGS. 10a-b show example user interfaces 500 showing a “STAR” based user capture achievement; FIGS. 10c-d show example user interfaces 502 showing mapping of user capture achievement to projects, school activities, etc.; and FIGS. 10e-f show example user interfaces 504 showing top career matches.

In another example, the methods and process described herein may be extended to non-professional applications, such as predicting user choices and preferences for fashion, food, etc., based on seemingly unrelated data points.

Additionally, from the extracted data and model predictions, the model provides additional features such as automatic generation of user summaries are formatted into a resume that users can download for job applications.

As stated above, other solutions focus on matching user supplied data to user supplied job descriptions or job titles, hence they do not auto-generate job titles tailored to the user based on generic user data without the user prompting or directing the model. In general, in the present system, the software (web and mobile) platform continuously tracks and captures user data and achievement, and the machine learning solution stack which utilizes both supervised learning, transfer learning to correlate user data to model predictions. The supervised learning facilitates applications such as making career predictions from user skills and projects, while transfer learning is used to map user skills, professional and non-professional achievements to industries by retraining and tailoring publicly available APIs that have been trained on large corpus of words for other use cases, and making these applicable to our own application.

The methods and system described herein require detailed data collection algorithm (using the web and mobile app) that is tailored to capture a wide range of user activities, and integrating this data collection with various machine learning models and APIs at various stages of the data collection to facilitate accurate and dynamic career predictions tailored to the individual as well as added features such as resume summary generation, possible job matches, mentorship opportunities etc. (which are delivered using the web and mobile app). Furthermore, NLP algorithms which utilize a basic process of data collection, stemming/lemmatization, generating a bag of words and corpus and finally feeding this into a model are not used. Due to the large amount of noise in the data (collected using web scrapping), the size of the bag of words is capped and the data gathering process is constrained to utilize only key phrases which were then further contained using a term frequency-inverse document frequency (tf-idf) to generate the training vectors. To be clear, capping the bag of words and using a using a term frequency-inverse document frequency are standard in the field, however further constraining this data cleaning process to extract key phrases whose occurrence are sorted from maximum to minimum before sending the data to the tf-idf algorithm is new and greatly improved our algorithm by reducing noise in the data.

Accordingly, the platform generates career choices tailored to the users based on their skills, professional and non-professional activities, and therefore the user does not have to provide their pre-determined careers of choice.

In another example, the system 10 provides feedback on the user's strengths, areas of opportunities and growth. The system 10 also receives input from people in the user's social and no-social circles e.g. family, professors, colleagues, friends etc. in order to create a pattern of their areas of interest, natural strength, and ability for mapping their career path.

In another example, the system 10 generates a chronological profile of user's professional and non-professional experience. When needed, users can prompt the system 10 to auto-create resumes and cover letters tailored to each job, by leveraging the profile extracts, skills exhibited and the impact of those skills. For example, users can prompt the system 10 to auto-generate job-optimized resumes by copying the job description and click on generate resume. The system 10 then triangulates across the various experiences, feedback captured over time, to create tailored resume/cover letter for the user.

In another example, experienced professionals can find out what their transferable skills are, and the other industries that they can transition into with respect to each country. This may be useful for new immigrants as they relocate to new countries.

In another example, schools and their career advisors may receive career predictions for each student (provided such permissions exist), and advisors can leverage those career predictions to provide a more tailored career guidance.

In another example, users can post a request for assistance and the app auto-notifies top 3 mentors based on the user's area of need. Mentors are prompted to reach out to the poster within 24-48 hrs to help them.

In another example, more robust algorithms based on transformers neural network or recurrent neural networks may be used.

In another example, an algorithm that auto-generates full resumes (rather than short resume summaries or resume block) may be used.

FIG. 11 illustrates a block diagram of an example of a machine 14 upon which any one or more of the techniques (e.g., methodologies) discussed herein can perform. In alternative embodiments, the machine 14 can operate as a standalone device or are connected (e.g., networked) to other machines. In a networked deployment, the machine 14 can operate in the capacity of a server machine, a client machine, or both in server-client network environments. In an example, the machine 14 can act as a peer machine in peer-to-peer (P2P) (or other distributed) network environment. The machine 14 is a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. In various embodiments, machine 14 can perform one or more of the processes described above. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms (all referred to hereinafter as “modules”). Modules are tangible entities (e.g., hardware) capable of performing specified operations and is configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a module that operates to perform specified operations. In an example, the software can reside on a non-transitory computer readable storage medium or other machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Machine 14 can include a hardware processor 16 (e.g., a central processing unit (CPU), a graphics processing unit (GPU), a hardware processor core, or any combination thereof), a main memory 18, and a static memory 606, some or all of which can communicate with each other via an interlink 608 (e.g., bus). The machine 14 can further include a display unit 610, an alphanumeric input device 612 (e.g., a keyboard), and a user interface (UI) navigation device 614 (e.g., a mouse). In an example, the display unit 610, input device 612 and UI navigation device 614 are a touch screen display. The machine 14 can additionally include a storage device (e.g., drive unit) 616, a signal generation device 618 (e.g., a speaker), a network interface device 620, and one or more sensors 621, such as an accelerometer, or other sensor. The machine 14 can include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 can include a machine readable medium 622 on which is stored one or more sets of data structures or instructions 624 (e.g., software) embodying or utilized by any one or more of the techniques or functions described herein, such as algorithms 22. The instructions 624 can also reside, completely or at least partially, within the main memory 18, within static memory 606, or within the hardware processor 16 during execution thereof by the machine 14. In an example, one or any combination of the hardware processor 16, the main memory 18, the static memory 606, or the storage device 616 can constitute machine readable media. While the machine readable medium 622 is illustrated as a single medium, the term “machine readable medium” can include a single medium or multiple media (e.g., a centralized or distributed database, and/or associated caches and servers) configured to store the one or more instructions 624.

The term “machine readable medium” can include any medium that is capable of storing, encoding, or carrying instructions for execution by the machine 14 and that cause the machine 14 to perform any one or more of the techniques of the present disclosure, or that is capable of storing, encoding or carrying data structures used by or associated with such instructions. Nonlimiting machine-readable medium examples can include solid-state memories, and optical and magnetic media. Specific examples of machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media can include non-transitory machine-readable media. In some examples, machine readable media can include machine readable media that is not a transitory propagating signal.

The instructions 624 can further be transmitted or received over a communications network 29 using a transmission medium via the network interface device 620. The machine 14 can communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 602.11 family of standards known as Wi-Fi®, IEEE 602.16 family of standards known as WiMax®), IEEE 602.15.4 family of standards, a Long Term Evolution (LTE) family of standards, a Universal Mobile Telecommunications System (UMTS) family of standards, peer-to-peer (P2P) networks, among others. In an example, the network interface device 620 can include one or more physical jacks (e.g., Ethernet, coaxial, or phonejacks) or one or more antennas to connect to the communications network 29. In an example, the network interface device 620 can include a plurality of antennas to wirelessly communicate using at least one of single-input multiple-output (SIMO), multiple-input multiple-output (MIMO), or multiple-input single-output (MISO) techniques. In some examples, the network interface device 620 can wirelessly communicate using Multiple User MIMO techniques.

Examples, as described herein, can include, or can operate on, logic or a number of components, modules, or mechanisms. Modules are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client, or server computer system) or one or more hardware processors are configured by firmware or software (e.g., instructions, an application portion, or an application) as a module that operates to perform specified operations. In an example, the software can reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Various embodiments are implemented fully or partially in software and/or firmware. This software and/or firmware can take the form of instructions contained in or on a non-transitory computer-readable storage medium. Those instructions can then be read and executed by one or more processors to enable performance of the operations described herein. The instructions are in any suitable form, such as but not limited to source code, compiled code, interpreted code, executable code, static code, dynamic code, and the like. Such a computer-readable medium can include any tangible non-transitory medium for storing information in a form readable by one or more computers, such as but not limited to read only memory (ROM); random access memory (RAM); magnetic disk storage media; optical storage media; flash memory; etc.

Each of the non-limiting aspects or examples described herein can stand on its own, or can be combined in various permutations or combinations with one or more of the other examples.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a GPU, an FPGA, or an ASIC.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system 10 can be interconnected by any form or medium of wireline and/or wireless digital data communication, e.g., a communications network 29. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations, and free-space optical networks. The network may communicate with, for example, Internet Protocol (IP) packets, Frame Relay frames, Asynchronous Transfer Mode (ATM) cells, voice, video, data, and/or other suitable information between network addresses.

The computing system can include clients and servers and/or Internet-of-Things (IoT) devices running publisher/subscriber applications. A client and server are generally remote from each other and typically interact through a communication network. The relationship of client and server arises by virtue of computer programs running on the respective computers and having a client-server relationship to each other.

There may be any number of computers associated with, or external to, the system 10 and communicating over network 29. Further, the terms “client,” “user,” and other appropriate terminology may be used interchangeably, as appropriate, without departing from the scope of this disclosure.

In another implementation, system 10 follows a cloud computing model, by providing an on-demand network access to a shared pool of configurable computing resources (e.g., servers, storage, applications, and/or services) that can be rapidly provisioned and released with minimal or nor resource management effort, including interaction with a service provider, by a user (operator of a thin client).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hard-ware and computer instructions.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of example embodiments of the invention makes reference to the accompanying drawings, which show the example embodiment by way of illustration. While these example embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description, and with respect to the attached claims.

1. A method for recommending a career to a user, the method comprising the steps of:
at processing circuitry executing instructions stored in a memory device, receiving raw user data;
preprocessing the raw user data;
extracting predefined content from the user data;
transforming text in the predefined content into frequency distribution and generating a predetermined number of feature vectors;
label encoding an output of each feature vector;
generating a training data set and a test data set from the feature vector output;
generating at least one model, and using the training data set and test data set to evaluate the performance of the at least one model;
receiving subject user data;
predicting the at least one career using the trained model on the subject user data; and
generating a report comprising the at least one career.

2. The method of claim 1, wherein the raw user data is gathered in real-time from user activities with mobile applications and internet activities and user profile.

3. The method of claim 2, wherein the trained model predicts at least one skill related to the user data.

4. The method of claim 3, wherein the trained model predicts at least one related industry based on the user data and the at least one skill.

5. The method of claim 4, wherein the trained model autogenerates at least one portion of a resume based on the user data, the at least one skill and at least one related industry.

6. The method of claim 5, wherein the trained model predicts at least one suitable career based on at least one of the user data, the at least one skill, the at least one related industry.

7. The method of claim 6, wherein the at least one suitable career is predicted dynamically in response to changes in the user profile, activities and interest.

8. A method for mapping a career for a user, the method comprising the steps of:
at processing circuitry executing instructions stored in a memory device, receiving raw user data comprising at least one of professional activities, non-professional activities, education, hobbies, skills, interests, and contemporaneous online user activities;
preprocessing the raw user data to generate user input data;
with a trained model, using the user input data to generate a plurality of potential careers for the user;
ranking the plurality of potential careers;
predicting the at least one career for the user; and
generating a report comprising the at least one career.

9. The method of claim 8, wherein the trained model comprises parameters including precision, recall and F1 score functionality.

10. The method of claim 9, wherein the trained model is evaluated for accuracy based on the F1 score.

11. The method of claim 10, wherein the F1 score is about 80%.

12. The method of claim 8, wherein the memory device comprises instructions executable by the processing circuitry to receive a user resume and suggest content for inclusion in the resume based on the predicted at least one career.

13. The method of claim 8, wherein the memory device comprises instructions executable by the processing circuitry to receive a user resume and suggest content for inclusion in the resume based on the predicted at least one career.

14. The method of claim 8, wherein the memory device comprises instructions executable by the processing circuitry to match the user to available job opportunities based on the predicted at least one career.

15. The method of claim 8, wherein the memory device comprises instructions executable by the processing circuitry to generate a dialog area on a user interface for interacting with the user by posing questions to capture the user's skills, interests and achievements.

16. A system for recommending a career to a user, the system comprising:
a hardware processor and a memory device on which instructions are encoded to cause the hardware processor to perform the operations of:
receiving raw user data;
preprocessing the raw user data;
extracting predefined content from the user data;
transforming text in the predefined content into frequency distribution and generating a predetermined number of feature vectors;
label encoding an output of each feature vector;
generating a training data set and a test data set from the feature vector output;
generating at least one model, and using the training data set and test data set to evaluate the performance of the at least one model;
receiving subject user data;
predicting the at least one career using the trained model on the subject user data; and
generating a report comprising the at least one career.

17. The system of claim 16, wherein the trained model autogenerates at least one portion of a resume based on the at least one career.

18. The system of claim 16, wherein the at least one suitable career is predicted dynamically in response to changes in the user profile, activities and interest.

19. The system of claim 18, wherein the at least one model comprises parameters including precision, recall and F1 score functionality.

20. The system of claim 19, wherein the at least one model is evaluated for accuracy based on the F1 score.
